(19) United States
(12) Patent Application Publication
(10) Pub. No.: US 2017/0312842 A1
(43) Pub. Date: Nov. 2, 2017

(54) Arc Gouging Box

(71) Applicant: Daniel Alexander LEBLANC, Calgary (CA)

(72) Inventor: Daniel Alexander LEBLANC, Calgary (CA)

(21) Appl. No.: 15/142,796

(22) Filed: Apr. 29, 2016

(51) Int. Cl. B23K 9/013; B23K 37/00; B23K 9/32

(52) U.S. Cl. CPC B23K 9/013; B23K 9/321; B23K 37/006

(57) ABSTRACT

A gouging box for safely removing debris and exhaust from the site of arc gouging work. The gouging box is a rigid open-bottomed frame having at least one access opening for insertion of a user's arm, a transparent viewing window, air inlet means, and an exhaust port. Fire retardant materials may cover the arm openings, and extend below the lower edges of the frame. A slag containment and air filtration unit may be added to the exhaust port to collect slag and reduce smoke in the work area.

### FIELD OF THE INVENTION

The present invention relates to safety equipment. In particular, the present invention relates to safety equipment for arc gouging operations.

### BACKGROUND OF THE INVENTION

Gouging is the industrial process used to cut a groove into a metal. Several methods of gouging exist, including mechanical techniques such as grinding, routing and chipping. The most common methods of gouging are plasma gouging and air carbon-arc gouging. Air carbon-arc carbon-arc gouging uses an electric arc at the end of a consumable carbon rod to melt the metal, while a compressed air flow removes the molten metal from the newly formed groove.

In the arc gouging environment, the reaction of the molten metal with air and the force of the compressed air flow cause dispersion of a high volume of metal vapor, carbon dust, and pieces of metal throughout the work area.

To contain the flying metal and other gouging by-products, prior art methods use large barriers to close off a work area, and the user is required to wear full safety gear while working inside the closed off area. Set up and removal of the safety barriers can be onerous, and require significant time.

It is also known in the welding industry art to provide smaller physical safety barriers which allow a user to contain the fumes generated by arc welding within a sealed container. In arc gouging, however, a fully sealed safety barrier to contain gases is not necessary nor practical.

It is desirable, therefore, to provide a small, adaptable gouging safety barrier, referred to herein as a “gouging box”, which may be easily set up and removed, which prevents metal removed by the gouging process from being dispersed throughout the work area, and which provides easy manual and visual access for the user.

The device of the present invention meets these requirements.

### BRIEF DESCRIPTION OF THE DRAWINGS

A detailed description of the preferred embodiments is provided by way of example only and with reference to the following drawings, in which:

FIG. 1 is an isometric view of a preferred embodiment of the invention, showing a gouging box having front arm access;

FIG. 2 is an isometric view of another embodiment of the invention, depicting a gouging box having top and front arm access;

FIG. 3 is an isometric view of another embodiment of the invention having an attached slag collection and air filtration unit;

FIGS. 4A-4C depict side plan views of the three components of the slag collection and air filtration unit;

FIGS. 4D-4F depict isometric views of the three components of the slag collection and air filtration unit;

FIG. 5 is a side plan view of the slag collection and air filtration unit, showing the air flow path; and

FIG. 6 is an isometric view of another embodiment of the invention, showing a gouging box having a non-planar bottom surface, with top panel arm access openings.

In the drawings, several embodiments of the invention are illustrated by way of example. It is to be expressly understood that the description and drawings are only for the purpose of illustration and as an aid to understanding, and are not intended as a definition of the limits of the invention.

### SUMMARY OF THE INVENTION

The invention comprises an open-bottomed arc gouging box for debris containment, comprising a rectangular top panel; a first side panel extending perpendicularly downward from a first edge of the top panel; a second side panel extending perpendicularly from a second edge of the top panel and joined along one side edge to the adjacent side edge of the first side panel; a third side panel extending perpendicularly from a third edge of the top panel and joined along one side edge to the adjacent side edge of one of the first of second side panels; a transparent window within a portion of at least one panel; a light source disposed on the inner surface of at least one of the panels; at least one air inlet in at least one of the side panels; an exhaust port in one of the side panels; means for generating air flow through the gouging box for controlled removal of air and debris from the interior of the gouging box; and at least one arm opening through at least one of the panels for access of a user's arm during gouging.

The gouging box may have a fourth side panel extending perpendicularly from a fourth edge of the top panel and joined along each side edge to an adjacent side edge of the adjacent side panel. The top panel and each of the side panels may be hinged along their adjacent edges. The air inlet may comprise an air valve connected to an air blower. There may be suction means such as vacuum connected to the exhaust port for drawing exhaust and debris from the interior of the gouging box.

One of the side panels may be a ventilation panel having a plurality of openings therein. The side panel housing the exhaust port may be funnel-shaped. There may be a fire-resistant barrier removably attached over each of the arm openings, and a fire retardant skirt suspendable from the lower edge of one or more of the side panels.

A slag collection container and air filter may be connected to the external end of the exhaust port. The slag containment and air filter nay have internal air flow guides to assist in debris containment.

Another embodiment of the invention is an open-bottomed arc gouging box for debris containment, comprising a rectangular top panel; opposing first and second end panels extending perpendicularly below opposing end edges of the top panel, wherein each end panel is generally triangular; first and second opposing side panels, each side panel extending perpendicularly below opposing side edges of the top panel; and joined along each side edge to an adjacent edge of an end panel; a transparent window within a portion of the top panel; a light source disposed on the inner surface of at least one of the panels; at least one air inlet in the first end panel; an exhaust port in the second end panel; means for generating air flow through the gouging box for controlled removal of air and debris from the interior of the gouging box; and at least one arm opening through at least one of the panels for access of a user's arm during gouging.

### DETAILED DESCRIPTION OF THE INVENTION

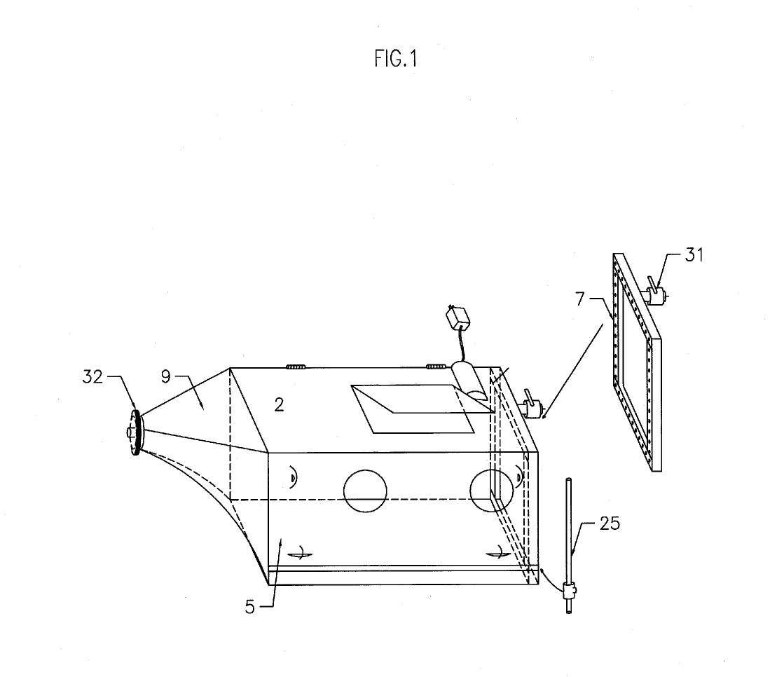

There is provided a gouging box for arc gouging. In the embodiment shown in FIG. 1, the gouging safety barrier comprises a top panel 2, a front side panel 5, a rear side panel, and a right side panel 7, each panel extending perpendicularly from a corresponding edge of the top panel to form an open-bottomed frame. The left side of the frame is enclosed by a funnel-shaped cover 9 extending from the adjacent side panels and top panel to a central exhaust port 32. The right side panel in the embodiment shown is a removable ventilation panel.

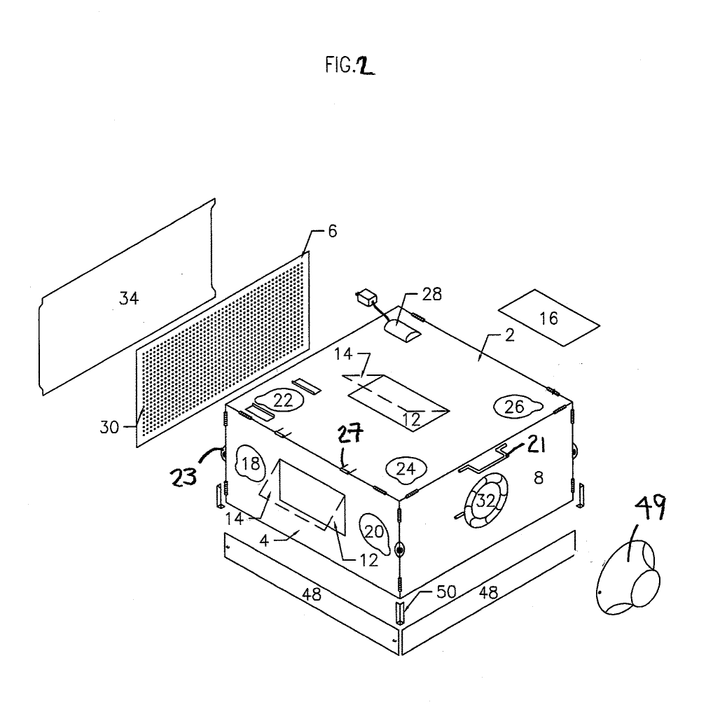

According to one embodiment shown in FIG. 2, the gouging box comprises a top panel 2 having an outer and an inner surface, a first side panel 4 extending perpendicularly from one edge of the top panel, a second side panel 8 extending perpendicularly from a second adjacent edge of the top panel and joined along one side edge to the adjacent side edge of the first panel, a third side panel extending perpendicularly from a third adjacent edge of the top panel and joined along one side edge to the adjacent side edge of the first or second side panel, wherein a portion of at least one panel comprises a transparent window 12, a light source 28 disposed on the inner surface of at least one of the panels, at least one ventilation opening 30 in at least one of the side panels, an exhaust port 32 in one of the side panels, suction means (not shown) for removing air and debris from the interior of the gouging box, and at least one opening 18, 20, 22, 24, 26 for access of a user's arm during gouging. The embodiment of FIG. 1 also provides an electrical insulated barrier 25 for the gouge box. The electrical insulated barrier serves to prevent the gouge box from grounding to the work surface. Another method of providing an electrical insulation barrier is to provide an Epoxy powder coating between the metal of the gouge box and the metal surface to be gouged. FIG. 1 also shows an air inlet valve for connection of an air blower to bring forced air into the gouging box.

Each of the side panels may be connected to adjacent side panels along their common edges using hinges, which may have removable pins. The top panel may be hinged to the rear side panel, and may further include one or more securing latches 27 for securely closing the top panel over the box formed by the four side panels. It should be noted that the side panels are interchangeable and each of the panels may be placed in the front, left, right or rear side of the gouging box. Within the top panel there is provided a transparent glass window for visual access to the work area. An electric light source may be connected to the top panel to provide light to the interior of the box.

In the embodiment shown in FIG. 2, the gouging box comprises a top panel, a front side panel, a left side panel, a rear side panel, and a right side panel, each panel extending perpendicularly from a corresponding edge of the top panel to form an open-bottomed box. Each of the side panels may be connected to adjacent side panels along their common edges using hinges, which may have removable pins. The top panel may be hinged to the rear side panel, and may further include one or more securing latches for securely closing the top panel over the box formed by the four side panels. It should be noted that the side panels are interchangeable and each of the panels may be placed in the front, left, right or rear side of the gouging box.

In an alternate embodiment, one or two of the side panels may be replaced with an angle form to provide structural support for the remaining two or three panels.

Within the top panel and one of the side panels there is provided a transparent glass window for visual access to the work area. There may be an opaque removable cover 14 over each of the windows. There may further be a cover plate 16 for attachment over the glass window.

The front side panel may contain one or more arm access openings. The top panel may also contain one or more arm access openings. Each of the arm access openings may be covered by a fire blanket. There may be provided arm access opening cover plates for covering openings which are not in use. There may be provided pairs of Weir clamps or other attachment means for reversibly attaching the fire blanket over each arm access opening. An electric light source may be connected to the top panel to provide light to the interior of the box.

One or more ventilation openings 30 may be provided in one or more of the side panels. An air exhaust valve and port may be provided in one side panel for removal of debris. Air flow generation means such as an air blower 31 or other source of air flow may be connected to the exhaust valve. A protective cover plate may be attached over the one or more ventilation openings. There may also be a cover plate 49 for attachment of a vent hose to the exhaust valve. A funnel insert may be provided inside the gouging box for directing exhaust and debris into the exhaust port for removal from the work area. One of the side panels may be a ventilation panel 6. A ventilation panel cover plate 34 may also be provided.

One or more lugs 23 may be connected at one or more corners of the gouging box for use in suspension of the box in a desired work location. Preferably, one or more handles 21 may be attached along opposing edges of the top panel for ease of lifting. One or more fire retardant skirts 48 may be attached to the bottom of one or more of the side panels for added protection against flying metal debris during gouging operations. Each skirt may be secured to the corners of the box with skirt fasteners 50. One or more adjustment pins may be used to set the length of the skirt below the side panel.

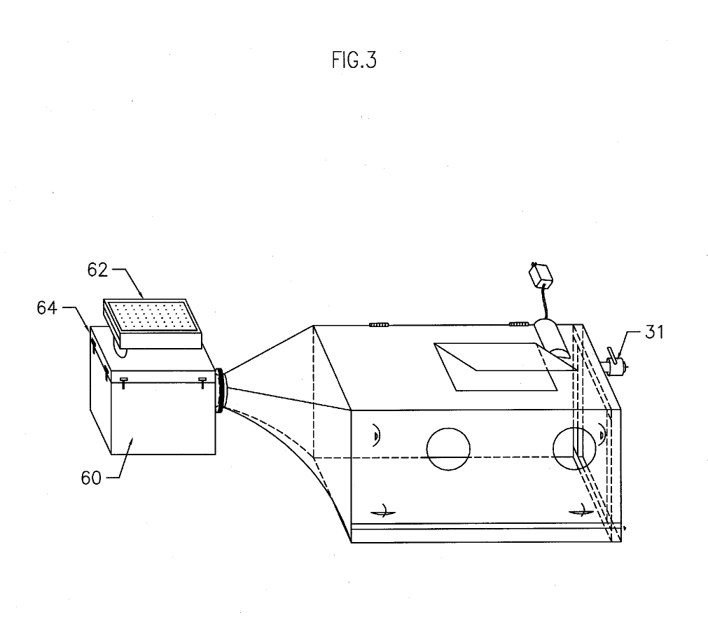

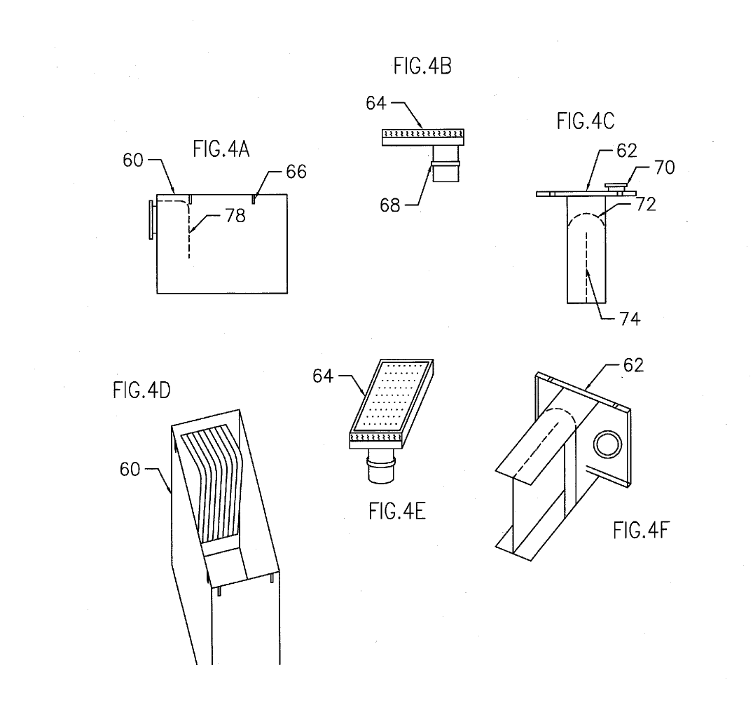

As shown ion FIGS. 3 and 4, a slag collection and air filtration unit may be attached to the gouging box to collect slag and filter other air borne debris from the exhaust prior to ventilation to the surrounding environment, in order to reduce sparks and smoke. The slag collection and air filtration unit comprises three components: a slag collection container 60 (FIGS. 4A and 4D), an air filter housing 62 (FIGS. 4B and 4E), and an air flow insert 64 (FIGS. 4C and 4F). The unit is assembled by sliding the air flow component into the slag collection container and pinning them together with pins 66, before inserting the flange 68 in the air filter housing into the opening 70 in the top of the air flow insert and pinning together. The air flow insert comprises guides 72, 74 to direct air flow through the slag containment unit to cause deposit of slag prior to air filtration. The slag containment unit further comprises an air flow guide 78 to direct exhaust air and debris toward the bottom of the unit upon entry.

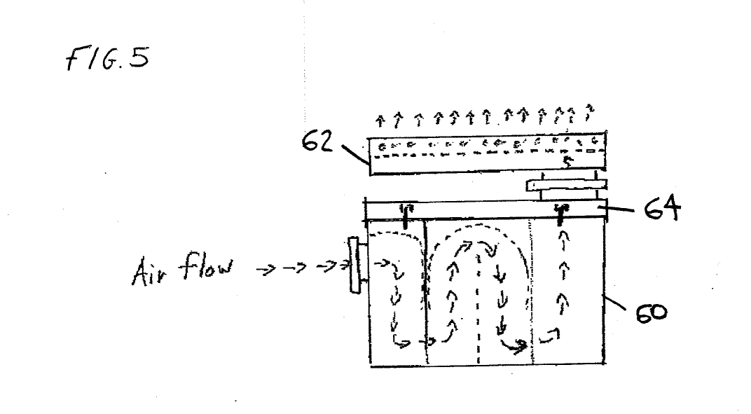

As may be seen in FIG. 5, exhaust and debris exiting the gouging box enters the slag collection container and is directed in an undulating vertical pattern through the air flow insert, depositing slag in the slag collection container. The exhaust then passes through the air filter housing to trap smaller debris and reduce smoke before exhausting to the surrounding environment.

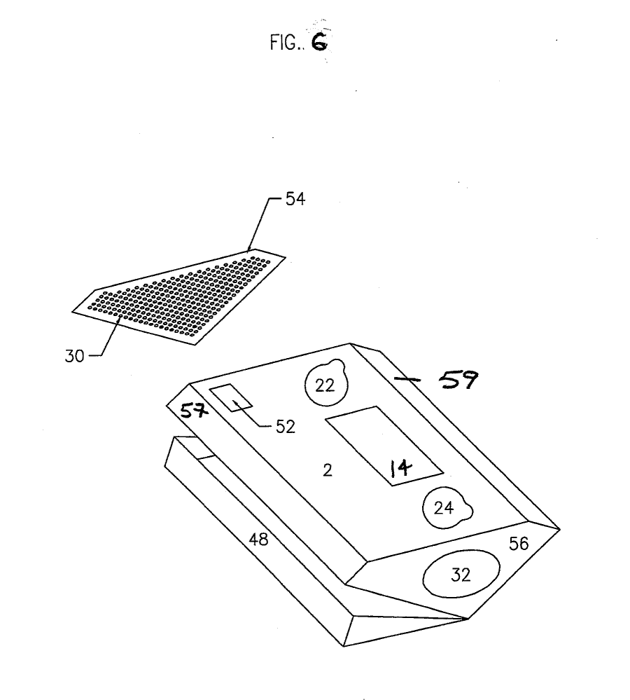

According to an alternate embodiment of the invention shown in FIG. 6, there is provided a gouging box for use when the support surface for the gouging box is not planar. In this embodiment, the left 54 and right 56 side panels of the box are not rectangular but form an acute angle at their lower edges for secure placement into an angled work surface. The front and rear panels 57, 59 are thereby reduced in size and primarily provide structural support. In this embodiment, the top panel includes the arm access openings 22, 24, visual access window and cover 14, and light source and cover 52. One angular side panel is provided with ventilation openings 30, and the opposing side panel is provided with an exhaust port 32 for removal of exhaust and debris from the work area. The top panel is hinged for opening to provide access to the work area. A fire retardant skirt 48 may be provided where the work surface does not match the lower perimeter of the safety barrier.

In operation, the gouging box may be installed over a work piece prior to commencing gouging. Once it is installed, the user may access the work piece with the gouging equipment using the arm access openings, and will have clear visual access during the work. The physical containment provided by the panels of the safety barrier prevent metal debris from leaving the immediate work area during gouging. Instead, the debris is carried out of the work area with the exhaust air flow.

The user is not required to be fully clothed in safety gear, as only the user's hands and arms will be within the work area, and the use of safety gloves may be sufficient. Importantly, only a small area in immediate proximity to the work piece is isolated from the work site. In contrast, in the prior art barrier method, a large section of the work site must be closed off to prevent injury from flying debris.

The present invention reduces risk of injury, decreases worker time spent setting up and dismantling safety barriers for gouging, and is easily adaptable to a wide variety of work surfaces.

It will be appreciated by those skilled in the art that other variations of the preferred embodiment may also be practiced without departing from the scope of the invention.

1. An open-bottomed arc gouging box for debris containment, comprising:
a. a rectangular top panel;
b. a first side panel extending perpendicularly downward from a first edge of the top panel;
c. a second side panel extending perpendicularly from a second edge of the top panel and joined along one side edge to the adjacent side edge of the first side panel;
d. a third side panel extending perpendicularly from a third edge of the top panel and joined along one side edge to the adjacent side edge of one of the first of second side panels;
e. a transparent window within a portion of at least one panel;
f. a light source disposed on the inner surface of at least one of the panels;
g. at least one air inlet in at least one of the side panels;
h. an exhaust port in one of the side panels;
i. means for generating air flow through the gouging box for controlled removal of air and debris from the interior of the gouging box; and
j. at least one arm opening through at least one of the panels for access of a user's arm during gouging.

2. The gouging box of claim 1, further comprising a fourth side panel extending perpendicularly from a fourth edge of the top panel and joined along each side edge to an adjacent side edge of the adjacent side panel.

3. The gouging box of claim 2, wherein the top panel and each of the side panels are hinged along their adjacent edges.

4. The gouging box of claim 2, further comprising an opaque removable cover over the window.

5. The gouging box of claim 2 wherein the air inlet comprises an air valve connected to an air blower.

6. The gouging box of claim 2, further comprising suction means connected to the exhaust port for drawing exhaust and debris from the interior of the gouging box.

7. The gouging box of claim 2 wherein one of the side panels is a ventilation panel having a plurality of openings therein.

8. The gouging box of claim 2, wherein the side panel housing the exhaust port is funnel-shaped.

9. The gouging box of claim 2, further comprising a fire-resistant barrier removably attached over each of the arm openings.

10. The gouging box of claim 2, further comprising a fire retardant skirt suspendable from the lower edge of one or more of the side panels.

11. The gouging box of claim 2, further comprising a slag collection container and air filter connected to the external end of the exhaust port.

12. The gouging box of claim 11, wherein the slag containment and air filter further comprises internal air flow guides to assist in debris containment.

13. An open-bottomed arc gouging box for debris containment, comprising:
a. a rectangular top panel;
b. opposing first and second end panels extending perpendicularly below opposing end edges of the top panel, wherein each end panel is generally triangular;
c. first and second opposing side panels, each side panel extending perpendicularly below opposing side edges of the top panel; and joined along each side edge to an adjacent edge of an end panel;
d. a transparent window within a portion of the top panel;
e. a light source disposed on the inner surface of at least one of the panels;
f. at least one air inlet in the first end panel;
g. an exhaust port in the second end panel;
h. means for generating air flow through the gouging box for controlled removal of air and debris from the interior of the gouging box; and
i. at least one arm opening through at least one of the panels for access of a user's arm during gouging.

14. The gouging box of claim 13 wherein the air inlet comprises an air valve connected to an air blower.

15. The gouging box of claim 13, further comprising suction means connected to the exhaust port for drawing exhaust and debris from the interior of the gouging box.

16. The gouging box of claim 13 wherein one of the side panels is a ventilation panel having a plurality of openings therein.

17. The gouging box of claim 13, wherein the side panel housing the exhaust port is funnel-shaped.

18. The gouging box of claim 13, further comprising a fire-resistant barrier removably attached over each of the arm openings.

19. The gouging box of claim 13, further comprising a slag collection container and air filter connected to the external end of the exhaust port.

20. The gouging box of claim 19, further comprising a fire retardant skirt suspendable from the lower edge of one or more of the side panels.
